(19) United States
(12) Patent Application Publication
(10) Pub. No.: US 2018/0258199 A1
(43) Pub. Date: Sep. 13, 2018

(54) PROCESS FOR THE PREPARATION OF CATALYST COMPONENTS FOR THE POLYMERIZATION OF OLEFINS

(71) Applicant: BASELL POLIOLEFINE ITALIA S.R.L., MILANO (IT)

(72) Inventors: GIANNI VITALE, FERRARA (IT); DARIO LIGUORI, FERRARA (IT); GIAMPIERO MORINI, FERRARA (IT)

(73) Assignee: BASELL POLIOLEFINE ITALIA S.R.L., MILANO (IT)

(21) Appl. No.: 15/759,419

(22) PCT Filed: Aug. 31, 2016
(86) PCT No.: PCT/EP2016/070440

§ 371 Date: Mar. 12, 2018

(30) Foreign Application Priority Data
Sep. 11, 2015 (EP) 15184880.1

(51) Int. Cl. C08F 10/06

(52) U.S. Cl. CPC C08F 10/06

(57) ABSTRACT

A process for preparing a solid catalyst component for the homopolymerization or copolymerization of CH₂═CHR olefins, wherein R is hydrogen or hydrocarbyl radical with 1-12 carbon atoms, including a step (a), at a temperature ranging from 0 to 150° C., of reacting a Mg based compound of formula (MgClₘX₂₋ₘ).nLB, wherein m ranges from 0 to 2, n ranges from 0 to 6, X is, independently R¹, OR¹, —OCOR¹ or O—C(O)—OR¹ group, wherein R¹ is a C₁-C₂₀ hydrocarbon group and LB is a Lewis base with a liquid medium made from or containing a Ti compound, having a Ti—Cl bond, in an amount such that the Ti/Mg molar ratio is higher than 3 and a Bi compound dissolved or dispersed in the liquid medium, wherein the solid catalyst compound is made from or contains the Ti compound, the Bi compound and optionally an electron donor on a Mg chloride based support.

### FIELD OF THE INVENTION

In general, the present disclosure relates to the field of chemistry. More specifically, the present disclosure relates to polymer chemistry. In particular, the present disclosure relates to a process for the preparation of catalyst components for the homopolymerization or copolymerization of olefins, made from or containing Mg, Bi, Ti and halogen elements and optionally an electron donor compound.

### BACKGROUND OF THE INVENTION

Catalyst components for the polymerization of olefins include Ziegler-Natta category components. In a first instance, a Ziegler-Natta catalyst system was based on the use of solid TiCl₃ obtained by reduction of TiCl₄ with aluminum alkyls. Because of the insufficient activity and stereospecificity of the catalysts, the resulting polymer was subjected to a de-ashing treatment to remove the catalyst residues and a washing step to remove any atactic polymer. Presently and in some instances, the Ziegler-Natta catalysts that are used industrially are made from or contain a solid catalyst component, constituted by a magnesium dihalide on which are supported a titanium compound and optionally an internal electron donor compound, used in combination with an Al-alkyl compound.

In some instances, the use of magnesium chloride based supports increased catalyst activities.

In some instances, when the Ziegler-Natta catalysts (“ZN catalysts”) are used for propylene polymerization, the catalysts contain an internal donor. In further instances, the ZN catalysts are used with an external donor to obtain higher isotacticity. Examples of internal donors are esters of phthalic acid, including diisobutylphthalate. In some instances, phthalates are used as internal donors in combination with alkylalkoxysilanes as external donors. It is desirable to increase the intrinsic capability of the solid catalyst components to produce stereoregular polymers, thereby allowing the use of less stereoregulating internal or external donors.

In some instances, ZN catalysts are improved by introducing substances into the ZN catalysts or the magnesium chloride based support. These substances are called “modifiers”.

In some instances, the presence of a modifier in the support is unnecessary or undesirable.

It is desirable to provide a process wherein the ZN catalysts are modified on demand without adversely affecting preparation of non-modified ZN catalysts.

It is further desirable to provide a process for the preparation of a solid catalyst component with improved activity or stereospecificity when polymerizing olefins.

### SUMMARY OF THE INVENTION

In a general embodiment, the present disclosure provides a process for the preparation of a solid catalyst component for the homopolymerization or copolymerization of CH₂═CHR olefins, wherein R is hydrogen or hydrocarbyl radical with 1-12 carbon atoms, including a step (a), at a temperature ranging from about 0 to about 150° C., of reacting (I) a Mg based compound of the formula (MgClₘX₂₋ₘ).nLB, wherein m ranges from 0 to 2, n ranges from 0 to 6, X is, independently R¹, OR¹, —OCOR¹ or O—C(O)—OR¹ group, wherein R¹ is a C₁-C₂₀ hydrocarbon group, and LB is a Lewis base with (II) a liquid medium made from or containing (i) a Ti compound, having a Ti—Cl bond, in an amount such that the Ti/Mg molar ratio is greater than about 3 and (ii) a Bi compound dissolved or dispersed in the liquid medium, wherein the solid catalyst component is made from or contains the Ti compound, the Bi compound and optionally an electron donor on a Mg chloride based support.

### DETAILED DESCRIPTION OF THE INVENTION

In some embodiments, the bismuth compound is dissolved or dispersed in a liquid medium made from or containing a titanium compound of formula Ti(OR¹)_{q-y}Cl_{y}, where q is the valence of titanium and y is a number between 1 and q and R¹ is a C₁-C₂₀ hydrocarbon group.

In some embodiments, the titanium compounds are titanium polyhalogenated compounds. In some embodiments, the titanium polyhalogenated compounds are selected from the group consisting of titanium tetrahalides and halogenalcoholates. In some embodiments, the titanium polyhalogenated compounds are selected from the group consisting of titanium tetrachloride and chloroalcoholates. In some embodiments, the titanium polyhalogenated compounds are selected from the group consisting of TiCl₄ and Ti(OEt)Cl₃.

In some embodiments, the liquid medium is made from or contains a mixture of the Ti compound in another liquid diluent. In some embodiments, the diluents are hydrocarbons, optionally chlorinated, that are liquid at room temperature. In some embodiments, the liquid medium consists of the liquid titanium compound.

In some embodiments, the magnesium based compound used as a starting compound in a first step (a) is selected from the group consisting of adducts of formula MgCl₂.nR¹OH, where n is a number between about 0.1 and about 6, and R¹ is a hydrocarbon radical having 1-18 carbon atoms. In some embodiments, n ranges from about 1 to about 5, alternatively from about 1.5 to about 4.5.

In some embodiments, the adduct is prepared by mixing alcohol and magnesium chloride, operating under stirring conditions at the melting temperature of the adduct (100-130° C.). Then, the adduct is mixed with an inert hydrocarbon immiscible with the adduct thereby creating an emulsion which is quickly quenched causing the solidification of the adduct in the form of spherical particles. In some embodiments, the procedure for the preparation of the spherical adducts are as disclosed in U.S. Pat. Nos. 4,399,054 and 4,469,648, both incorporated herein by reference.

In some embodiments, the method for spherulization is the spray cooling described in U.S. Pat. Nos. 5,100,849 and 4,829,034, both incorporated herein by reference. In some embodiments, the final alcohol content of the adducts is obtained directly from the amount of alcohol used during the adduct preparation.

In some embodiments, the adduct is directly reacted with Ti compound or subjected to thermal controlled dealcoholation (80-130° C.), thereby obtaining an adduct in which the number of moles of alcohol is lowered and the adduct's porosity increased. In some embodiments, the dealcoholation brings the number of moles of alcohol per mole of Mg to less than about 3, alternatively between about 0.1 and about 2.5.

In some embodiments, the reaction between the Mg based compound and the Ti compound is carried out by suspending the Mg based compound in large excess of cold TiCl₄; the mixture is heated up to a temperature ranging from about 60 to about 140° C. and kept at this temperature for 0.1-4 hours, alternatively 0.5-2 hours. After that time, stirring is discontinued and after the settlement of the solid particles the liquid phase is removed. In some embodiments, the temperature of the cold TiCl₄ is about 0° C.

In some embodiments, the reaction step (a) is carried out one or more times under identical or different conditions. In some embodiments, the temperature and duration of treatment are changed. In some embodiments, the number of steps (a) is between 1 and 4.

In some embodiments, the electron donor compound is added during a reaction step (a).

In some embodiments, the electron donor compound is added during a first reaction step (a). In some embodiments, the reaction step (a) is repeated one or two additional times.

In some embodiments, the electron donor compound is added as a fresh reactant to the solid intermediate catalyst component obtained by a reaction between the adduct and the Ti compound, as described in Patent Cooperation Treaty Publication No. WO2004/106388, incorporated herein by reference.

In some embodiments, the reaction step (a) is carried out by a continuous feeding of liquid Ti compound in an apparatus and under conditions that are described in Patent Cooperation Treaty Publication No. WO02/48208, incorporated herein by reference. In some embodiments, the Mg based compound is fed batchwise while a continuous stream of liquid Ti compound is fed and a liquid phase containing dissolved reaction product is continuously withdrawn. In some embodiments, the Bi compound and, optionally, the electron donor is added at any time during the feeding of the Ti compound. In some embodiments, the liquid Ti compound is TiCl₄.

In some embodiments, the liquid medium is made from or contains the titanium compound and a dissolved or dispersed Bi compound.

In some embodiments, the Bi compounds do not have Bi-carbon bonds. In some embodiments, the Bi compounds are selected from the group consisting of Bi halides, Bi carbonate, Bi acetate, Bi nitrate, Bi oxide, Bi sulphate, and Bi sulfide. In some embodiments, the Bi compounds have the valence +3. In some embodiments, the Bi compounds are selected from the group consisting of Bi trichloride and Bi tribromide. In some embodiments, the Bi compound is BiCl₃.

In some embodiments, the amount of bismuth compound dispersed or solubilized in the liquid medium ranges from about 0.005 to about 0.1 mole per mole of Mg based compound, alternatively from about 0.010 to about 0.040.

In some embodiments, the preparation of a liquid mixture includes dissolving or dispersing the Bi compound in the liquid medium made from or containing the Ti compound and then reacting the mixture with the Mg based compound.

In some embodiments, the Bi compound is used in one or more reaction steps (a). In some embodiments, the Bi compound is used in one reaction step (a).

In some embodiments, the solid catalyst component is subjected to washings with hydrocarbon solvents at the end of the last reaction step (a), until chloride ions are not detectable.

In some embodiments, the process for the preparation of a solid catalyst component for the homopolymerization or copolymerization provides a catalyst component having a content of Bi ranging from about 0.5 to about 40 wt %, alternatively from about 0.5 to about 35, alternatively from about 0.5 to about 20, alternatively from about 1 to about 20 wt %, based upon the total amount of the solid catalyst component.

In some embodiments, the particles of the solid catalyst component have substantially spherical morphology and average diameter ranging between about 5 and about 150 μm, alternatively from about 20 to about 100 μm, alternatively from about 30 to about 90 μm. In the present description, the term “substantially spherical morphology” as used herein refers to particles having the ratio between the greater axis and the smaller axis equal to or lower than about 1.5, alternatively lower than about 1.3.

In some embodiments, the amount of Mg ranges from about 8 to about 30 wt %, alternatively from about 10 to about 25 wt %, based upon the total weight of the solid catalyst component.

In some embodiments, the amount of Ti ranges from about 0.5 to about 5 wt %, alternatively from about 0.7 to about 3 wt %, based upon the total weight of the solid catalyst component.

In some embodiments, the Mg/Ti molar ratio is greater than the corresponding ratio of the catalyst not containing Bi.

In some embodiments, the internal electron donor is selected from the group consisting of ethers, amines, silanes, carbamates, ketones, esters of aliphatic acids, alkyl and aryl esters of optionally substituted aromatic polycarboxylic acids, diol derivatives selected from the group consisting of dicarbamates, monoesters monocarbamates and monoesters monocarbonates and mixtures thereof.

In some embodiments, the internal donor is selected from alkyl and aryl esters of optionally substituted aromatic polycarboxylic acids. In some embodiments, the internal donors are esters of phthalic acids. In some embodiments, the internal donors are esters of aliphatic acids selected from the group consisting of malonic, glutaric, maleic and succinic acids. In some embodiments, the internal donors are selected from the group consisting of n-butylphthalate, di-isobutylphthalate, and di-n-octylphthalate.

In some embodiments, the internal donor is selected from the group consisting of 1,3 diethers of the formula (I):

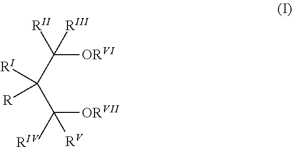

wherein R, R^{I}, R^{II}, R^{III}, R^{IV} and R^{V} are equal to or different from each other, and are hydrogen or hydrocarbon radicals having from 1 to 18 carbon atoms; and R^{VI} and R^{VII} are equal to or different from each other, and have the same meaning of R—R^{V} except that R^{VI} and R^{VII} cannot be hydrogen; one or more of the R—R^{VII} groups can be linked to form a cycle. In some embodiments, the 1,3-diethers have R^{VI} and R^{VII} selected from C₁-C₄ alkyl radicals.

In some embodiments, the internal donor is a mixture of donors. In some embodiments, the mixture includes mixtures of esters of succinic acids and 1,3 diethers as disclosed in Patent Cooperation Treaty Publication No. WO2011/061134, incorporated herein by reference.

In some embodiments, the electron donor is selected from the group consisting of monofunctional donors, thereby distributing an olefin comonomer within a polymer chain. In some embodiments, the monofunctional donors are selected from the group consisting of ethers and C₁-C₄ alkyl esters of aliphatic mono carboxylic acids. In some embodiments, the ethers are selected from the group consisting of C₂-C₂₀ aliphatic ethers, alternatively cyclic ethers. In some embodiments, the cyclic ethers have 3-5 carbon atoms, such as tetrahydrofurane and dioxane. In some embodiments, the esters are selected from the group consisting of ethylacetate and methyl formiate.

In some embodiments, the final amount of electron donor compound in the solid catalyst component ranges from about 0.5 to about 40 wt %, alternatively in the range from about 1 to about 35 wt %, based upon the total weight of the solid catalyst component.

In some embodiments, the donor belongs to alkyl and aryl esters of optionally substituted aromatic polycarboxylic acids and the Mg/Ti molar ratio is equal to, or greater than, about 13, alternatively in the range from about 14 to about 40, alternatively from about 15 to about 40. In some embodiments, the Mg/donor molar ratio is greater than about 16, alternatively higher than about 17, alternatively ranging from about 18 to about 50. In some embodiments, the alkyl and aryl esters are phthalates.

In some embodiments, the donor belongs to diethers of formula (I), the Mg/Ti molar ratio is greater than about 6, alternatively higher than about 7, and the Mg/donor molar ratio ranges from about 9 to about 20, alternatively from about 10 to about 20.

In some embodiments, the solid catalyst component shows a surface area (by B.E.T. method) between about 20 and about 500 m²/g, alternatively between about 50 and about 400 m²/g, and a total porosity (by B.E.T. method) greater than about 0.2 cm³/g, alternatively between about 0.3 and about 0.6 cm³/g. In some embodiments, the porosity (Hg method) due to pores with radius up to about 10.000 Å, ranges from about 0.3 to about 1.5 cm³/g, alternatively from about 0.45 to about 1 cm³/g.

In some embodiments, the solid catalyst component has an average particle size ranging from about 5 to about 120 μm, alternatively from about 10 to about 100 μm.

In some embodiments, the solid catalyst component is converted into catalysts for the polymerization of olefins by reacting the solid catalyst component with organoaluminum compounds.

In some embodiments, the organoaluminum compound is selected from the group consisting of trialkyl aluminum compounds, alkylaluminum halides, alkylaluminum hydrides and alkylaluminum sesquichlorides. In some embodiments, the trialkyl aluminum compounds are selected from the group consisting of tri ethyl aluminum, triisobutylaluminum, tri-n-butylaluminum, tri-n-hexylaluminum, and tri-n-octylaluminum. In some embodiments, the alkylaluminum sesquichlorides are selected from the group consisting of AlEt₂Cl and Al₂Et₃Cl₃. In some embodiments, the organoaluminum compound is a mixture with trialkylaluminums.

In some embodiments, the Al/Ti ratio is greater than about 1, alternatively between about 50 and about 2000, alternatively between about 50 and about 500.

In some embodiments, an external electron-donor compound is used. In some embodiments, the external electron-donor compound is selected from the group consisting of silicon compounds, ethers, esters, amines, heterocyclic compounds and 2,2,6,6-tetramethylpiperidine and ketones. In some embodiments, the external donor compounds is selected from the group consisting of silicon compounds of formula (R₆)ₐ(R₇)_{b}Si(OR₈)_{c}, where a and b are integers from 0 to 2, c is an integer from 1 to 4 and the sum of (a+b+c) is 4; R₆, R₇, and R₈, are alkyl, cycloalkyl or aryl radicals with 1-18 carbon atoms optionally containing heteroatoms. In some embodiments, the silicon compounds have a is 1, b is 1, and c is 2, at least one of R₆ and R₇ selected from the group consisting of branched alkyl, cycloalkyl or aryl groups with 3-10 carbon atoms optionally containing heteroatoms, and R₈ is a C₁-C₁₀ alkyl group. In some embodiment, R₈ is methyl. In some embodiments, the external electron-donor compound is a silicon compound selected from the group consisting of methylcyclohexyldimethoxysilane (C donor), diphenyldimethoxysilane, methyl-t-butyldimethoxysilane, dicyclopentyldimethoxysilane (D donor), diisopropyldimethoxysilane, (2-ethylpiperidinyl)t-butyldimethoxysilane, (2-ethylpiperidinyl)thexyldimethoxysilane, (3,3,3-trifluoro-n-propyl)(2-ethylpiperidinyl)dimethoxysilane, and methyl(3,3,3-trifluoro-n-propyl)dimethoxysilane. In some embodiments, the silicon compounds have a is 0 and c is 3, R₇ is a branched alkyl or cycloalkyl group, optionally containing heteroatoms, and R₈ is methyl. In some embodiments, the external electron-donor compound is a silicon compound selected from the group consisting of cyclohexyltrimethoxysilane, t-butyltrimethoxysilane and thexyltrimethoxysilane.

In some embodiments, the external electron donor compound is used in an amount to give a molar ratio between the organoaluminum compound and the external electron donor compound of from about 0.1 to about 500, alternatively from about 1 to about 300, alternatively from about 3 to about 100.

In a general embodiment, the present disclosure provides a process for the homopolymerization or copolymerization of CH₂═CHR olefins, in which R is hydrogen or a hydrocarbyl radical with 1-12 carbon atoms.

In some embodiments, the polymerization process is carried out in slurry polymerization using as diluent, an inert hydrocarbon solvent, or bulk polymerization using the liquid monomer as a reaction medium. In some embodiments, the liquid monomer is propylene. In some embodiments, the polymerization process occurs in gas-phase operating in one or more fluidized or mechanically agitated bed reactors.

In some embodiments, the polymerization temperature ranges from about 20 to about 120° C., alternatively from about 40 to about 80° C. In some embodiments, when the polymerization is carried out in gas-phase, the operating pressure is between about 0.5 to about 5 MPa, alternatively between about 1 to about 4 MPa. In some embodiments, when the polymerization is carried out in bulk polymerization, the operating pressure ranges between about 1 to about 8 MPa, alternatively between about 1.5 to about 5 MPa.

In some embodiments, the Bi compound is incorporated into the solid catalyst component without including the Bi compound into the Mg based compound used as a support precursor. In some embodiments, the Mg based compound is used in catalyst preparation without Bi compounds.

In some embodiments, the catalyst component produces polypropylene with an isotacticity, expressed in terms of xylene insolubility, of at least about 98% alternatively higher than about 98.5, alternatively higher than about 99%.

The following examples are given in order to better illustrate the disclosure without limiting it.

### EXAMPLES

### Characterizations

### Determination of Mg, Ti

The determination of Mg and Ti content in the solid catalyst component was carried out via inductively coupled plasma emission spectroscopy on “I.C.P Spectrometer ARL Accuris”.

The sample was prepared by analytically weighing, in a “Fluxy” platinum crucible, 0.1 to 0.3 grams of catalyst and 2 grams of lithium metaborate/tetraborate 1/1 mixture. After addition of some drops of KI solution, the crucible was inserted in a “Claisse Fluxy” apparatus for the complete burning. The residue was collected with a 5% v/v HNO₃ solution and then analyzed via ICP at the following wavelengths: Magnesium, 279.08 nm and Titanium, 368.52 nm.

### Determination of Bi

The determination of Bi content in the solid catalyst component was carried out via inductively coupled plasma emission spectroscopy on “I.C.P Spectrometer ARL Accuris”.

The sample was prepared by analytically weighing in a 200 cm³ volumetric flask 0.1 to 0.3 grams of catalyst. After slow addition of both about 10 milliliters of 65% v/v HNO3 solution and about 50 cm³ of distilled water, the sample underwent a digestion for 4+6 hours. Then the volumetric flask was diluted to the mark with deionized water. The resulting solution was directly analyzed via ICP at the following wavelength: Bismuth, 223.06 nm.

### Determination of Internal Donor Content

The determination of the content of internal donor in the solid catalytic compound was done through gas chromatography. The solid component was dissolved in acetone, an internal standard was added, and a sample of the organic phase was analyzed in a gas chromatograph, to determine the amount of donor present at the starting catalyst compound.

### Determination of X.I.

In a round-bottomed flask provided with a cooler and a reflux condenser, 2.5 g of polymer and 250 ml of o-xylene were placed and kept under nitrogen. The mixture was heated to 135° C. and kept under stirring for about 60 minutes. The final solution was allowed to cool to 25° C. under continuous stirring, and the insoluble polymer was then filtered. The filtrate was then evaporated in a nitrogen flow at 140° C. to reach a constant weight. The content of the xylene-soluble fraction was expressed as a percentage of the original 2.5 grams and then, by difference, the X.I. %.

### Melt Flow Rate (MFR)

The melt flow rate MFR of the polymer was determined according to ISO 1133 (230° C., 2.16 Kg).

### Procedure for the Preparation of the Mg Based Compound I (Spherical Adduct)

Microspheroidal MgCl₂.pC₂H₅OH adduct was prepared according to the method described in Example 2 of WO98/44009. The solid spherical particles obtained, containing 57 wt % of ethanol, underwent a dealcoholation step under warm nitrogen flow until the level of ethanol reached 50 wt %.

### Procedure for the Preparation of the Mg Based Compound II (Spherical Adduct)

Microspheroidal MgCl₂.pC₂H₅OH adduct was prepared according to the method described in Example 2 of Patent Cooperation Treaty No. WO98/44009, incorporated herein by reference with the difference that BiCl₃ in a powder form and in the amount indicated in Table 1 was added in the step of molten MgCl2-EtOH adduct preparation. Containing 57 wt % of ethanol, the solid spherical particles underwent a dealcoholation step under warm nitrogen flow until the level of ethanol reached 50 wt %.

### Procedure for the Preparation of the Mg Based Compound III

The synthesis of the precursor was performed as described in Example 1 of U.S. Pat. No. 4,220,554, incorporated herein by reference. The support had the following composition: Mg, 20.2 wt.%; Cl, 29.8 wt.%; and EtOH groups 41.5 wt.%.

### Procedure for the Preparation of the Phthalate-Based Solid Catalyst Component

Into a 500 ml round bottom flask, equipped with a mechanical stirrer, cooler and thermometer, 300 ml of TiCl₄ were introduced at room temperature under nitrogen atmosphere. After cooling to 0° C., while stirring, BiCl₃ in a powder form, diisobutylphthalate (DIBP), and 15.0 g of the Mg based compound I, II or III were sequentially added into the flask. The amount of BiCl₃ and diisobutylphthalate added were as reported in Table 1. The amount of fed internal donor was such to meet a Mg/donor molar ratio indicated in Table 1. The temperature was raised to 100° C. and maintained for 1 hour (first step (a)). Thereafter, stirring was stopped, the solid product was allowed to settle, and the supernatant liquid was siphoned off at 100° C. After the supernatant was removed, additional fresh TiCl₄ was added at room temperature together with, if used, diisobutylphthalate in the amount indicated in Table 1 to reach the initial liquid volume again. The mixture was then heated at 120° C. and kept at this temperature for 30 minutes (second step (a)). Stirring was stopped again, the solid was allowed to settle and the supernatant liquid was siphoned off at 100° C. After the supernatant was removed, additional fresh TiCl₄ was added at room temperature to reach the initial liquid volume again. The mixture was then heated at 120° C. and kept at this temperature for 15 minutes (third step (a)). Stirring was stopped again, the solid was allowed to settle and the supernatant liquid was siphoned off at 100° C. The solid was washed with anhydrous heptane four times in temperature gradient down to 90° C. and one time at 25° C. The solid was then dried under vacuum and analyzed.

### Procedure for the Preparation of the Glutarate-Based Solid Catalyst Component

The preparation of the glutarate-based solid catalyst component was the same as the phthalate-based solid catalyst component with the difference that diethyl, 3,3-dipropylglutarate was used instead of diisobutylphthalate and the temperature of the first step (a) was 120° C. instead of 100° C.

Mg based compound, amount of glutarate, amount of BiCl₃ and Mg/glutarate molar ratio are reported in Table 2.

### General Procedure for the Polymerization of Propylene

A 4-liter steel autoclave equipped with a stirrer, pressure gauge, thermometer, catalyst feeding system, monomer feeding lines and thermostating jacket, was purged with nitrogen flow at 70° C. for one hour. A suspension containing 75 ml of anhydrous hexane, 0.76 g of AlEt₃ (6.66 mmol), 0.33 mmol of external donor and 0.006 to 0.010 g of solid catalyst component, precontacted for 5 minutes, was charged. Either dicyclopentyldimethoxysilane, D donor, or cyclohexylmethyldimethoxysilane, C donor, was used as an external donor as specified in Tables 1 and 2.

The autoclave was closed and hydrogen was added. For D donor tests, 2 NL of hydrogen was added. For C donor tests, 1.5 NL of hydrogen was added. Then, under stirring, 1.2 kg of liquid propylene was fed. The temperature was raised to 70° C. in about 10 minutes and the polymerization was carried out at this temperature for 2 hours. At the end of the polymerization, the non-reacted propylene was removed; the polymer was recovered and dried at 70° C. under vacuum for 3 hours. Then the polymer was weighed and characterized.

The polymerization results for the phthalate-based solid catalyst component are reported in Table 1, while the results for the glutarate-based solid catalyst component are reported in Table 2.

TABLE 1
Propylene polymerization using phthalate-based solid catalyst components

| | | Solid Catalyst Component synthesis | | | | | | | |
|---|---|---|---|---|---|---|---|---|---|
| | | | Aliquot | Aliquot | | Polymerization | | | |
| | Mg | | of DIBP | of DIBP | | | Yield | | |
| | based | Mg/DIBP | in the 1^{st} | in the 2^{nd} | Mg/Bi | ED | PPKg/ | XI | MI L |
| | comp. | % mol | step (a) % | step (a) %. | % mol | type | gTi | % wt. | g/10 min |
| Ex. 1 | I | 8 | 100 | 0 | 40 | C | 55.0 | 98.5 | 7.6 |
| Ex. 2 | I | | | | | D | 66.8 | 99.1 | 2.3 |
| Ex. 3 | I | 10 | 100 | 0 | 20 | C | 63.5 | 98.6 | 6.5 |
| Ex. 4 | I | | | | | D | 64.8 | 98.9 | 2.7 |
| Ex. 5 | I | 10 | 100 | 0 | 40 | C | 60.6 | 98.6 | 8.4 |
| Ex. 6 | I | | | | | D | 75.0 | 99.1 | 2.4 |
| Ex. 7 | I | 10 | 100 | 0 | 100 | C | 61.5 | 98.5 | 5.8 |
| Ex. 8 | I | | | | | D | 72.8 | 98.6 | 2.6 |
| Ex. 9 | I | 10 | 0 | 100 | 40 | C | 55.1 | 98.8 | 7.6 |
| Ex. 10 | I | | | | | D | 61.5 | 99.3 | 2.1 |
| Ex. 11 | I | 10 | 64 | 36 | 40 | C | 57.2 | 98.7 | 6.1 |
| Ex. 12 | I | | | | | D | 58.5 | 99.2 | 1.2 |
| Ex. 13 | III | 10 | 100 | 0 | 60 | C | 67 | 98.7 | 4.0 |
| Ex. 14 | III | | | | | D | 83.2 | 99.2 | 1.1 |
| Comp | I | 8 | 100 | 0 | — | C | 55.9 | 97.9 | 8.3 |
| Ex. 15 | | | | | | | | | |
| Comp | I | | | | | D | 73.9 | 98.8 | 2.2 |
| Ex. 16 | | | | | | | | | |
| Comp | III | 10 | 100 | 0 | 0 | C | 60.6 | 98.1 | 4.7 |
| Ex. 17 | | | | | | | | | |
| Comp | III | | | | | D | 79.1 | 98.8 | 2.4 |
| Ex. 18 | | | | | | | | | |

Aliquot of DIBP in the first step (a) + Aliquot of DIBP in the second step (a) = 100

TABLE 2
Propylene polymerization using glutarate-based solid catalyst components

| | Solid Catalyst Component synthesis | | | | | | | | |
|---|---|---|---|---|---|---|---|---|---|
| | | | Aliquot | Aliquot | | Polymerization | | | |
| | | | of Glu | of Glu | | | Yield | | |
| | Mg based | Mg/Glu | in the 1^{st} | in the 2^{nd} | Mg/Bi | ED | PPKg/g | XI | MI L |
| | compound | % mol | step (a) % | step (a) % | % mol | type | Ti | % wt. | g/10 min |
| Ex. 19 | I | 7 | 50 | 50 | 60 | C | 56.8 | 98.5 | 3.4 |
| Ex. 20 | I | | | | | D | 78.4 | 98.7 | 3.7 |
| Ex. 21 | I | 7 | 50 | 50 | 40 | C | 59.2 | 98.7 | 1.3 |
| Ex. 22 | I | | | | | D | 70.2 | 99.0 | 1.6 |
| Ex. 23 | I | 7 | 50 | 50 | 20 | C | 46.4 | 98.6 | 3.6 |
| Ex. 24 | I | | | | | D | 52.9 | 99.0 | 0.9 |
| Comp | II | 7 | 50 | 50 | 40 | C | 48.5 | 98.3 | 3.4 |
| Ex. 25 | | | | | | | | | |
| Comp | II | | | | | D | 65.8 | 99.0 | 2.1 |
| Ex. 26 | | | | | | | | | |
| Comp | I | 7 | 50 | 50 | — | C | 47.0 | 97.5 | — |
| Ex. 27 | | | | | | | | | |
| Comp | I | | | | | D | 56.0 | 98.3 | — |
| Ex. 28 | | | | | | | | | |

Aliquot of Glu in the first step (a) + Aliquot of Glu in the second step (a) = 100

What is claimed is:

1. A process for the preparation of a solid catalyst component for the homopolymerization or copolymerization of olefins CH₂═CHR, wherein R is hydrogen or hydrocarbyl radical with 1-12 carbon atoms, comprising:
(A) a step (a), at a temperature ranging from about 0 to about 150° C. of reacting
(I) a Mg based compound of formula (MgClₘX₂₋ₘ).nLB, wherein m ranges from 0 to 2, n ranges from 0 to 6, X is, independently R¹, OR¹, —OCOR¹ or O—C(O)—OR¹ group wherein R¹ is a C₁-C₂₀ hydrocarbon group and LB is a Lewis base with
(II) a liquid medium comprising
(i) a Ti compound having at least a Ti—Cl bond in an amount such that the Ti/Mg molar ratio is greater than about 3 and
(ii) a Bi compound dissolved or dispersed in the liquid medium,
wherein the solid catalyst component comprises the Ti compound, the Bi compound and optionally an electron donor on a MG chloride based support.

2. The process of claim 1, wherein the Bi compound is dissolved or dispersed in a liquid medium comprising a Ti compound of formula Ti(OR¹)_{q-y}Cl_{y}, where q is the valence of the titanium and y is a number between 1 and q and R¹ is a C₁-C₂₀ hydrocarbon group.

3. The process of claim 2, wherein the Ti compound is selected from the group consisting of titanium tetrachloride and chloroalcoholates.

4. The process of claim 1, wherein the Mg based compound is selected from adducts of formula MgCl₂.nR¹OH, where n is a number between about 0.1 and about 6, and R¹ is a hydrocarbon radical having 1-18 carbon atoms.

5. The process of claim 4, wherein n is from about 1 to about 5.

6. The process of claim 1, wherein the liquid medium consists of the liquid Ti compound.

7. The process claim 6, wherein the reaction temperature is from about 60 to about 140° C.

8. The process of claim 1, wherein the number of steps (a) is between 1 and 4.

9. The process of claim 1, wherein the Bi compound is selected from the group consisting of Bi halides.

10. The process of claim 1, wherein the amount of Bi compound dispersed or solubilized in the liquid medium ranges from about 0.005 to about 0.1 mole per mole of Mg based compound.

11. The process of claim 10, wherein the amount of Bi compound dispersed or solubilized in the liquid medium ranges from about 0.010 to about 0.040 mole per mole of Mg based compound.

12. The process of claim 1, wherein the Bi compound is used in one reaction step (a).

13. The process of claim 12, having a first step (a) and a second step (a) wherein the Bi compound is used in the first step (a).

14. The process of claim 1, wherein the electron donor compound is selected from the group consisting of alkyl and aryl esters of optionally substituted aromatic polycarboxylic acids, esters of malonic acids, esters of glutaric acids, esters of maleic acids, esters of succinic acids, diol derivatives selected from the group consisting of dicarbamates, monoesters monocarbamates and monoesters monocarbonates, and 1,3 diethers of the formula: 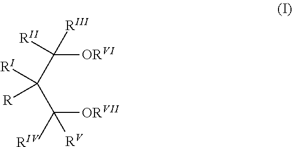
wherein R, R^{I}, R^{II}, R^{III}, R^{IV} and R^{V} are equal to or different from each other, and are hydrogen or hydrocarbon radicals having from 1 to 18 carbon atoms, and R^{VI} and R^{VII} are equal to or different from each other, and have the same meaning of R—R^{V} except that R^{VI} and R^{VII} cannot be hydrogen; and one or more of the R—R^{VII} groups may be linked to form a cycle.

15. The process of claim 13, wherein the internal donor is added during a first reaction step (a).
